(19) United States
(12) Patent Application Publication
(10) Pub. No.: US 2009/0021650 A1
(43) Pub. Date: Jan. 22, 2009

(54) Common receiver for terrestrial TV and CATV

(75) Inventor: Shigeto Masuda, Osaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 12/219,193

(22) Filed: Jul. 17, 2008

(30) Foreign Application Priority Data
Jul. 19, 2007 (JP) 2007-188536

(51) Int. Cl. H04N 5/50

(52) U.S. Cl. 348/731; 348/E05.097

(57) ABSTRACT

A tuner section 1 includes: an RF signal input terminal 2 via which multichannel RF signals are supplied; an AGC circuit 4, by which the RF signal input terminal 2 is followed, for fixing or controlling a gain in accordance with a first gain control signal; a broadband amplifying circuit 5, by which the AGC circuit 4 is followed; an AGC circuit 6, by which the broadband amplifying circuit 5 is followed, for fixing or controlling a gain in accordance with a second gain control signal,; a mixer circuit 7 for selecting and picking out a target channel signal from signals supplied from the AGC circuit 6; and an AGC switching circuit 15 for controlling gains of the AGC circuit 4 and the AGC circuit 6 by selecting whether to fix or to control a gain of the AGC circuit 4 while selecting whether to fix or to control a gain of the AGC circuit 6.

This Nonprovisional application claims priority under 35 U.S.C. §119(a) on Patent Application No. 188536/2007 filed in Japan on Jul. 19, 2007, the entire contents of which are hereby incorporated by reference.

### FIELD OF THE INVENTION

The present invention relates to a common receiver for terrestrial TV and CATV.

### BACKGROUND OF THE INVENTION

Recently, digitalization of broadcasting has been progressed, and needs of a receiver which can receive a plurality of broadcasting signals for terrestrial TV broadcasting, CATV broadcasting, and the like have been increasing.

Accordingly, different performances are required for a receiver to receive the broadcasting signals. This is because (i) each of the broadcasting signals is transmitted via a different transmission medium such as an air transmission or a cable transmission and (ii) transmission conditions such as the number of channels and a signal intensity vary from broadcasting type to broadcasting type.

For example, in CATV broadcasting, multichannel broadcasting signals for 134 channels are transmitted so as to have an approximately uniform signal intensity of −64 dBm to −34 dBm in an RF signal -transmission band that is a frequency band of 54 MHz to 864 MHz (U.S. CATV broadcasting specification), and its signal range is 30 dB. For this reason, performances such as low distortion, i.e., an excellent distortion characteristic, and an excellent impedance matching characteristic are required for a receiver for receiving CATV broadcasting signals so that the receiver is capable of dealing with multichannel reception.

On the other hand, in terrestrial TV broadcasting, broadcasting signals for 68 channels are transmitted in the RF signal transmission band that is a frequency band of 54 MHz to 806 MHz (U.S. terrestrial TV broadcasting specification). Although the number of channels for the terrestrial TV broadcasting is about a half of that for the CATV broadcasting, its signal range is 60 dB, which is a double of that of the CATV, because the broadcasting signals are transmitted so as to have a signal intensity of about −80 dBm to about −20 dBm. On this account, performances such as a low-noise performance and a broad dynamic range performance are required for such a receiver for receiving terrestrial TV broadcasting signals. The performances are determined substantially by capabilities of a tuner section provided in a receiver. The tuner section selects and picks out an intended channel from various broadcasting channels.

The following description deals with a low-distortion characteristic that is required for CATV reception.

Since a non-linear device is used for each of an amplifying circuit and a mixer circuit that are used in the tuner section, an amplitude distortion occurs and causes an intermodulation interference and a harmonic interference. Especially, in a case where many signals are supplied, such an intermodulation interference often adversely affects a broadband amplifier and a broadband mixer circuit. The following describes, as an example, a case of CATV broadcasting having a broadcasting signal reception band in a range of 54 MHz to 864 MHz.

In a case where two broadcasting signals of 100 MHz frequency and 150 MHz frequency belong to a single broadcasting signal reception band, for example, many intermodulation distortions as below occur.

100 [MHz]+150 [MHz]=250 [MHz]

2×100 [MHz]+150 [MHz]=350 [MHz]

2×150 [MHz]−100 [MHz]=200 [MHz]

The more the number of signals increases, the more often such intermodulation distortions occur. In addition, as the number of signals increases, the number of overlapping at least two intermodulation distortions which occur at the same frequency further increases. Each of the overlapping at least two intermodulation distortions has a different combination of a frequency (fundamental frequency) of a broadcasting signal and a frequency of a higher harmonic of the broadcasting signal, both of which cause the intermodulation distortions. The intermodulation distortions thus occurred interfere reception of broadcasting signals having the same frequencies as the frequencies at which the intermodulation distortions occur.

FIG. 8 is a graph illustrating an exemplary characteristic of a relation between an input signal level and an output signal level in an amplifying circuit. As illustrated in FIG. 8, a secondary intermodulation distortion becomes larger as an input signal level becomes higher. Here, a frequency of the secondary intermodulation distortion is a frequency that is equal to a sum or a difference of two broadcasting signals to be supplied to an amplifying circuit.

The following description deals with a noise figure that affects reception characteristics of a receiver such as receiving sensitivity.

Here is an example in which first and second circuit blocks are connected in cascade in this order, the first block has a gain of G1 and a noise figure of NF1, and the second block has a gain of G2 and a noise figure of NF2. In such an example, a total of a noise figure (NF total) is expressed by the following equation.

NF total=NF1+(NF2−1)/G1

As is apparent from the equation, the total of the noise figure (NF total) becomes smaller, as a value of the first noise figure (NF1) becomes smaller and the first gain (G1) becomes larger. The smaller the total of the noise figure (NF total) is, the better a noise characteristic of a receiver becomes.

On this account, in order that a distortion characteristic is improved, it is preferable that an input signal level be lowered. Moreover, in order that a noise characteristic is improved, it is necessary that a noise figure of a first tuner be set as small as possible and its gain be set as high as possible.

An operation of a conventional terrestrial TV broadcasting reception tuner 101 that is generally used is described below with reference to FIG. 9.

A great number of channel signals supplied to an RF signal input terminal 102 pass through a band pass filter 103 which causes channel signals, whose frequencies are close to a reception band, to be passed so that out-of-band signals are removed, and are then supplied to an AGC circuit 104. The AGC means Auto Gain Control. The AGC circuit 104 carries out a gain control for the channel signals in accordance with an AGC control signal supplied from an AGC control signal input terminal 105 so that the tuner 101 always supplies a constant output level regardless of size of supplied channel signal levels. Subsequently, the output signal of the AGC circuit 104 is supplied to a band pass filter 106 which removes out-of-band signals again, and is then supplied to a subsequent mixer circuit 107. The signal supplied to the mixer circuit 107 is mixed with a local oscillation signal which varies depending on a reception frequency, which is generated from a local oscillation circuit 108, so that the signal supplied to the mixer circuit 107 is converted into an IF signal which has an IF frequency. The IF signal thus converted is sent from a tuner output terminal 111, via a band pass filter 109 and an IF amplifying circuit 110. Generally, a frequency synthesizer made up of a PLL circuit 112 is used for controlling an oscillation frequency of the local oscillation circuit 108, which PLL circuit 112 can easily carry out a digital control and has a high frequency stability. Frequency setting data, which the PLL circuit 112 uses for an oscillation frequency control, is supplied from a microcomputer 114 via a data bus 113.

A CATV broadcasting reception tuner is generally arranged such that (i) a PIN attenuator circuit is used as an AGC circuit because the PIN attenuator circuit has an excellent impedance matching characteristic and an excellent distortion characteristic and (ii) the PIN attenuator circuit is followed by an RF signal amplifying circuit that is a broadband amplifying circuit having a flat frequency characteristic over a wide band.

FIG. 10 illustrates a conventional terrestrial digital TV broadcasting reception tuner 115, which has a function of receiving CATV broadcasting, and for which a low-noise performance is further required. In the terrestrial digital TV broadcasting reception tuner 115, an AGC circuit 116 which is made up of a PIN attenuator circuit is provided, and the AGC circuit 116 is followed by (i) an RF signal amplifying circuit 117, which is a broadband amplifying circuit, and (ii) an AGC circuit 118. Other arrangements are the same as the terrestrial TV broadcasting reception tuner 101 illustrated in FIG.9. In this case, a gain control is carried out with respect to an RF signal by two AGC circuits, that is, the AGC circuit 116 which is made up of the PIN attenuator circuit and the AGC circuit 118. In a conventional technique, the two AGC circuits are controlled simultaneously by a single AGC control signal supplied via an AGC control signal input terminal 119.

FIG. 11 is a frequency spectrum illustrating an intermodulation interference characteristic that is obtained when a conventional receiver receives CATV broadcasting. FIG. 11 reveals that there is a large intermodulation interference component in a frequency band of 44.5 MHz.

For example, Japanese Unexamined Patent Publication, Tokukaihei, No. 10-276109 (published on Oct. 13, 1998) discloses a television signal reception tuner, (i) which matches impedance of a cable even in the case of a channel other than reception channels, (ii) which causes little leakage of local oscillation signals supplied from an antenna input terminal, and further (iii) which improves its noise figure (NF). Moreover, Japanese Unexamined Patent Publication, Tokukai, No. 2001-102947 (published on Apr. 13, 2001) discloses an automatic gain control circuit and a receiver including the automatic gain control circuit, each of which ensures a stable and excellent reception quality regardless of received channels and reception wave circumstance.

However, the conventional terrestrial digital TV broadcasting reception tuner 115 of FIG. 10 causes the following problem.

Since the terrestrial digital TV broadcasting reception tuner 115 of FIG. 10 is arranged such that the two AGC circuits operate consistently at the same time, a total attenuation of RF signals attenuated in the two AGC circuits are shared by (i) the AGC circuit 116 followed by the RF signal amplifying circuit 117 and (ii) the AGC circuit 118 by which the RF signal amplifying circuit 117 is followed. From this reason, in reception of CATV broadcasting, which should have an excellent distortion characteristic, signal attenuation is not sufficiently carried out by the AGC circuit 116 which is followed by the RF signal amplifying circuit 117. This causes a problem that an amplified RF signal is distorted.

Moreover, in reception of terrestrial TV broadcasting, even in a case where an input signal has a low level, the AGC circuit 116 which is followed by the RF signal amplifying circuit 117 operates, thereby resulting in that the tuner 115 has a large total noise figure (NF total). This causes a problem that a tuner has a deteriorated reception performance.

### SUMMARY OF THE INVENTION

The present invention is accomplished in view of the above problems. An object of the present invention is to provide a common receiver for terrestrial TV and CATV, in which no distortion of RF signals or no deterioration of a reception capability occurs while a CATV broadcasting signal or a terrestrial TV broadcasting signal is received.

In order to achieve the above object, a common receiver for terrestrial TV and CATV of the present invention includes: an RF signal input terminal via which multichannel RF signals are supplied; first gain control means, by which the RF signal input terminal is followed, for fixing or controlling a gain in accordance with a first gain control signal; an RF signal amplifier, by which the first gain control means is followed; second gain control means, by which the RF signal amplifier is followed, for fixing or controlling a gain in accordance with a second gain control signal; a channel select circuit for selecting and picking out a target channel signal from signals supplied from the second gain control means; and control means for controlling gains of the first gain control means and the second gain control means by selecting whether to fix or to control a gain of the first gain control means while selecting whether to fix or to control a gain of the second gain control means.

With the circuit configuration of the common receiver for terrestrial TV and CATV of the present invention, (i) one of the first gain control means followed by the RF signal amplifier and the second gain control means by which the RF signal amplifier is followed has a gain-fixed status and (ii) the other one of the first gain control means and the second gain control means carries out a gain control., in accordance with whether a receiving signal is for CATV broadcasting or for terrestrial TV broadcasting.

With the configuration, it is possible to realize an excellent common receiver for terrestrial TV and CATV, having a good receiving performance with little noise and beat, in which an excellent distortion characteristic is ensured for receiving CATV broadcasting and a low-noise characteristic is ensured during receiving terrestrial TV broadcasting.

### BRIEF DESCRIPTION OF THE DRAWINGS

FIG. 1 is a block view illustrating a tuner section in a broadband multichannel signal receiver.

FIG. 2 is a view illustrating an example of control data of the present invention.

FIG. 3 is a view illustrating an exemplary setting of switch changeover control data corresponding to each operational situation of a broadband multichannel signal receiver of the present invention.

FIG. 4 is a circuit diagram of a PIN attenuator circuit. FIG. 5 is a graph illustrating a characteristic of a PIN diode.

FIG. 6 is a circuit diagram of an AGC circuit of the present invention.

FIG. 7 is a frequency spectrum illustrating an intermodulation interference characteristic when a common receiver for terrestrial TV and CATV of the present invention receives CATV broadcasting.

FIG. 8 is a graph illustrating an exemplary characteristic of a relation between an input signal level and an output signal level in an amplifying circuit.

FIG. 9 is a block view illustrating a conventional terrestrial TV broadcasting reception tuner.

FIG. 10 is a block view of a conventional terrestrial digital TV broadcasting reception tuner, which has a function for receiving CATV broadcasting, and for which a low-noise performance is further required.

FIG. 11 is a frequency spectrum illustrating an intermodulation interference characteristic when a conventional receiver receives CATV broadcasting.

### DESCRIPTION OF THE EMBODIMENTS

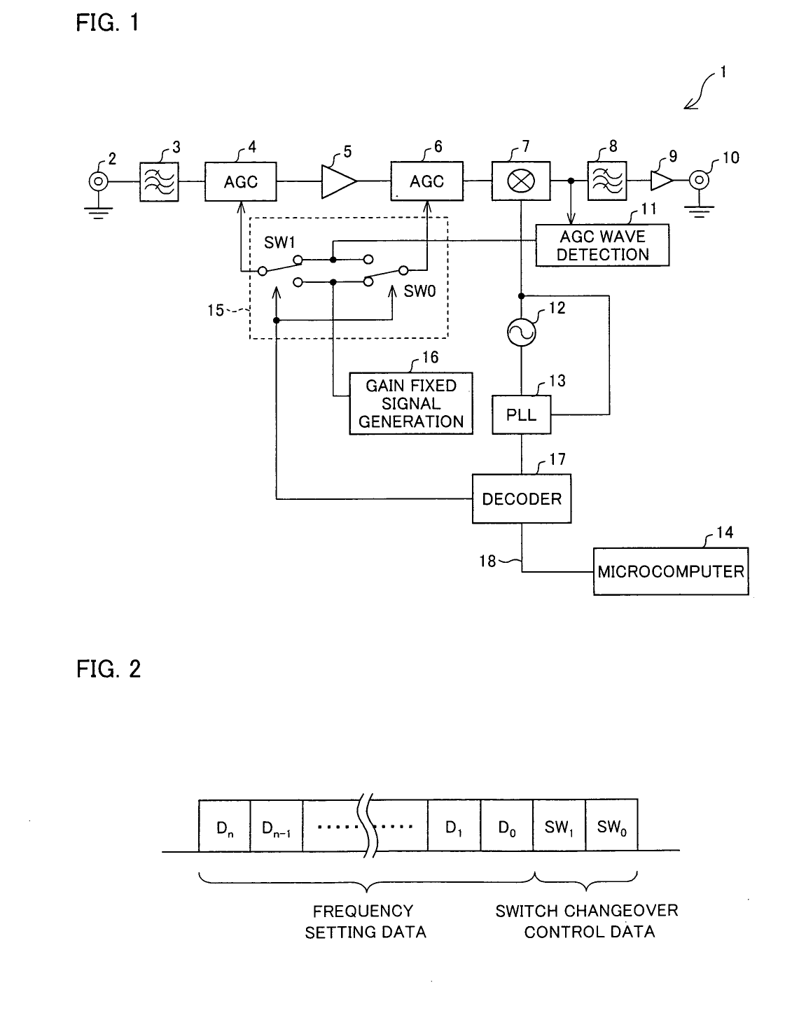

One embodiment of the present invention is explained as follows with reference to FIGS. 1 through 7.

FIG. 1 illustrates a tuner section 1 in a broadband multichannel signal receiver of the present invention. The tuner section 1 includes an RF signal input terminal 2, a band pass filter 3, an AGC circuit 4, a broadband amplifying circuit 5, an AGC circuit 6, a mixer circuit 7, a band pass filter 8, an amplifier 9, a tuner output terminal 10, an AGC wave detection circuit 11, a local oscillation circuit 12, a PLL circuit 13, a microcomputer 14, an AGC switching circuit 15, a gain fixed signal generation circuit 16, a decoder 17, and a data bus 18. The AGC switching circuit 15 includes a changeover switch SWO and a changeover switch SW1.

Multichannel RF signals supplied via the RF signal input terminal 2 are sent to the mixer circuit 7, via the band pass filter 3, the AGC circuit 4, the broadband amplifying circuit 5 and the AGC circuit 6. In the mixer circuit 7, the RF signals thus processed are mixed with a signal oscillated by the local oscillation circuit 12. This causes each of the RF signals thus mixed to be subjected to a frequency conversion so as to have an IF frequency. To put it differently, the mixer circuit 7 selects and picks out a target signal from the signals supplied from the AGC circuit 6.

The signals which have been subjected to the frequency conversion are sent out via the tuner output terminal 10, via the band pass filter 8 and the amplifier 9. The signals which have been subjected to the frequency conversion are also sent to the AGC wave detection circuit 11, which determines size of the signal levels and generates a signal, i.e., a gain control signal, for causing a gain control to be carried out so that the signal levels become a suitable signal level.

The AGC wave detection circuit 11 supplies a gain control signal to the AGC switching circuit 15. The AGC switching circuit 15 has a function of selecting whether (i) to supply a gain fixed signal generated from the gain fixed signal generation circuit 16 to the AGC circuit 4 and send the gain control signal supplied from the AGC wave detection circuit 11 to the AGC circuit 6, or (ii) to supply the gain fixed signal to the AGC circuit 6 and send the gain control signal supplied from the AGC wave detection circuit 11 to the AGC circuit 4. The gain fixed signal is a signal causing a gain of the AGC circuit 4 or the AGC circuit 6 to be set to a predetermined fixed gain. A frequency of an oscillation signal generated by the local oscillation circuit 12 is controlled by the PLL circuit 13. Data causing such a frequency to be controlled is ultimately supplied to the PLL circuit 13 from the microcomputer 14, via the data bus 18. A signal supplied from the AGC switching circuit 15 to the AGC circuit 4 is referred to as a first gain control signal. The gain fixed signal or the gain control signal is used as the first gain control signal. Similarly, a signal transmitted from the AGC switching circuit 15 to the AGC circuit 6 is referred to as a second gain control signal. The gain fixed signal or the gain control signal is used as the second gain control signal.

Data transmitted ultimately to the PLL circuit 13 from the microcomputer 14 via the data bus 18 has a data structure (see the exemplary data of FIG. 2) in which (i) PLL frequency setting data D₀ through Dₙ and (ii) switch changeover control data SW₀ and SW₁ are combined. Such combined data is supplied to the decoder 17, via a bus line that is one system of the data bus 18. The data is divided by the decoder 17 into PLL frequency setting data D₀ through Dₙ and switch changeover control data SW₀ and SW₁. The PLL frequency setting data D₀ through Dₙ are supplied to the PLL circuit 13, and the PLL circuit 13 sets a frequency of an oscillation signal generated by the local oscillation circuit 12. The switch changeover control data SW₀ and SW₁ are supplied to the AGC switching circuit 15 so as to be used as data for causing the switching to be controlled between the changeover switches SW0 and SW1.

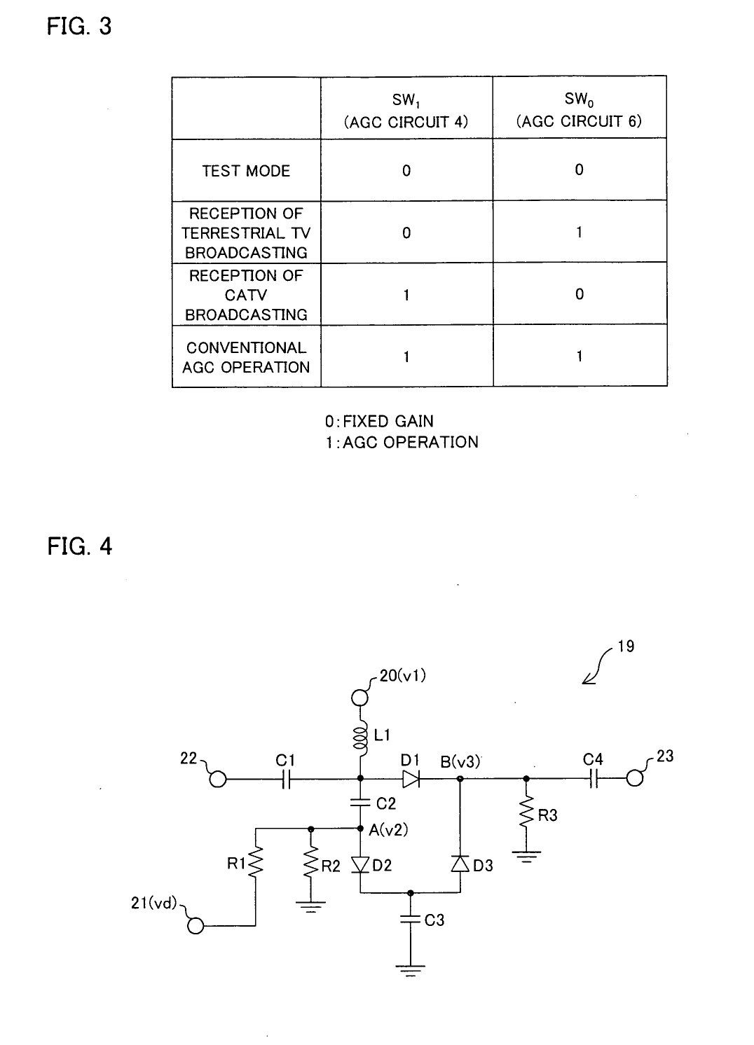

It is assumed that, in a case where the switch changeover control data SW₀ and SW₁ are expressed by 2-bit data as illustrated in FIG. 3, a gain of an AGC circuit is fixed when data “0” is supplied, and an AGC circuit carries out an AGC operation when data “1” is supplied.

In a case where terrestrial TV broadcasting is to be received, in order that a noise characteristic is improved as much as possible, it is necessary to increase as much as possible a gain of the AGC circuit 4 (a first stage AGC circuit of the tuner section 1 in the broadband multichannel signal receiver) which is followed by the broadband amplifying circuit 5. In other words, it is necessary for the AGC circuit 4 to attenuate supplied signals as little as possible. On this account, it is preferable that the AGC circuit 4 have a fixed maximum gain, which causes supplied signals to have a minimal attenuation. For this reason, the switch changeover control data SW₁ is set to “0” so that the AGC circuit 4 has a fixed maximum gain. In this case, an auto gain control (AGC) is carried out only by the AGC circuit 6 with respect to RF signals which the tuner section 1 receives. Therefore, the switch changeover control data SW₀ is set to “1” so that the AGC circuit 6 carries out an AGC operation.

In a case where CATV broadcasting is to be received, in order that a distortion characteristic is improved, it is necessary to reduce to an appropriate level the levels of RF signals to be supplied to the broadcasting amplifying circuit 5. In such a case, the switch changeover control data SW₁ is set to “1” so that a gain control is carried out with respect to the AGC circuit 4 followed by the broadband amplifying circuit 5. This causes the RF signals, which is supplied to the broadband amplifying circuit 5, to have sufficiently reduced levels, thereby resulting in that amplified signals, to be sent from the broadband amplifying circuit 5, have no distortion. Meanwhile, the switch changeover control data SW₀ is set to “0” so that the AGC circuit 6 has a fixed gain.

A fixed gain of the AGC circuit 6, i.e., a gain of the AGC circuit 6 which is fixed by setting the switch changeover control data SW₀ to “0”, is generally set to a maximum gain because (i) it is advantageous in view of a noise and (ii) the setting to a maximum gain is easily carried out. However, a fixed gain is not necessarily set to the maximum gain, and can be set to a gain most suitable for a system. In addition, although the present embodiment deals with a case where gains of the AGC circuit 4 and the AGC circuit 6 are controlled to be a fixed gain in accordance with single data “0”, it is also possible to control each of the gains to be a different fixed gain in accordance with different data.

Here is an example in which, (i) when the switch changeover control data SW₀ or SW₁ is “0”, a gain is controlled to be a first fixed gain; (ii) when the SW₀ or SW₁ is “1”, a gain is controlled to be a second fixed gain; and (iii) when the SW₀ or SW₁ is “2”, an AGC operation is carried out.

In a case where (i) the switch changeover control data SW₀ and SW₁ are set to “0” and (ii) gain control voltages for the AGC circuit 4 which is realized by a PIN attenuator circuit 19 (as described later) and the AGC circuit 6 are set to 4 V, the AGC circuit 4 and the AGC circuit 6 are controlled to have the first fixed gain. This minimizes power loss in the AGC circuit 4 while causing the AGC circuit 6 to have a maximum gain of 30 dB. In this case, when there occurs no loss in the band pass filter 3, a gain obtained when including the mixer circuit 7 remains too high, i.e., 30 dB. This may cause the AGC circuit 6 to output distorted amplified signals.

In view of this, when (i) the switch changeover control data SW₀ is set to “0” and the switch changeover control data SW₁ is set to “1”, and (ii) a control voltage of the AGC circuit 4 is set to 4 V and a control voltage of the AGC circuit 6 is set to 2 V, the AGC circuit 4 is controlled to have the first fixed gain and the AGC circuit 6 is controlled to have the second fixed gain. This causes the AGC circuit 6 to have a gain of 20 dB, thereby allowing the amplified signals to have reduced distortions.

Moreover, if, for example, the combination (SW₀, SW₁) of the 2-bit switch changeover control data SW₀ and SW₁ is set to (0, 0), then the AGC circuit 4 and the AGC circuit 6 are both set to have fixed gains. This can be used as a test mode for measuring a tuner performance or the like. Furthermore, if the combination (SW₀, SW₁) of the switch changeover control data SW₀ and SW₁ is set to (1, 1), then it is possible that the AGC circuit 4 and the AGC circuit 6 carry out their AGC operations at the same time in a similar manner to a conventional technique.

The present embodiment deals with a case of 2-bit switch changeover control data SW₀ and SW₁ as illustrated in FIG. 3. Note however that it is also possible to carry out a switch changeover control based on 1-bit data, in a case where such a test mode and conventional AGC operations are not necessary.

FIG. 4 is a circuit diagram of a PIN attenuator circuit 19 which is used as the AGC circuit 4 of FIG. 1. A signal supplied from the band pass filter 3 via an AGC circuit input terminal 22 of the PIN attenuator circuit 19 is sent out via an AGC circuit output terminal 23 of the PIN attenuator circuit 19 to the broadband amplifying circuit 5. Diodes D1 through D3 of FIG.4 are PIN diodes whose high-frequency resistor rd can be varied by changing a forward current If as illustrated in FIG. 5.

In the PIN attenuator circuit 19, one end of a capacitor C1 is connected to the AGC circuit input terminal 22, and the other end of the capacitor C1 is connected to an anode of the diode D1. One end of a capacitor C2 is connected to an anode of the diode D1, and the other end of the capacitor C2 is connected to an anode of the diode D2. One end of a capacitor C3 is connected to a cathode of the diode D2, and the other end of the capacitor C3 is connected to a GND (circuit ground). Moreover, one end of a capacitor C4 is connected to a cathode of the diode D1 and the other end of the capacitor C4 is connected to the AGC circuit output terminal 23.

In a case where the PIN attenuator circuit 19 is used as an AGC circuit, firstly, an AGC voltage v1, which is an AGC control signal, is applied to the AGC control signal input terminal 20 via which a signal from the AGC switching circuit 15 is supplied. When a greatest AGC voltage v1, which causes the PIN attenuator circuit 19 (serving as an AGC circuit) to have a minimal attenuation of signals which are supplied to the circuit 19, in other words, which causes the PIN attenuator circuit 19 to have a maximum gain, is applied via the AGC control signal input terminal 20, a current flows ultimately to a resistor R3, via a high frequency cutoff coil L1 and the diode D1. Note that a voltage v2 of a node A is a voltage obtained by divining, in accordance with a resistor R1 and a resistor R2, a power supply voltage vd which is supplied via a power supply terminal 21. The voltage v2 is set to be lower than a voltage v3 of a node B which is obtained when a maximum AGC voltage is applied.

As such, the diode D2 and the diode D3 are subjected to reverse bias in view of the relation between the voltage v2 of the node A and the voltage v3 of the node B, while the maximum AGC voltage is applied. This causes no current to flow the diodes D2 and D3. From this reason, an input-output characteristic of the PIN attenuator circuit 19, i.e., an attenuation characteristic found based on (i) an input signal which is supplied via the AGC circuit input terminal 22 and (ii) an output signal which is sent out via the AGC circuit output terminal 23 depends only on an attenuation due to a high-frequency resistor of the diode D1.

As the AGC voltage v1 is decreased, a current flowing the diode D1 decreases and a high-frequency resistor of the diode D1 increases, thereby resulting in that an attenuation due to the high-frequency resistor of the diode D1 increases. Thus, a gain of the PIN attenuator circuit 19 decreases. In addition, as the AGC voltage v1 decreases, the voltage v3 of the node B also decreases. When the voltage v2 becomes larger than the voltage v3 (v2>v3), the diode D2 and the diode D3 are subjected to forward bias. This causes a current to flow the diodes D2 and D3. Since the current flowing the diode D1 further decreases, an attenuation further increases, thereby further decreasing the gain. As the voltage v3 is more and more reduced, currents flowing the diodes D2 and D3 increase, thereby resulting in that a current flowing the diode D1 decreases and the attenuation increases. Thus, the gain decreases.

In this way, the PIN attenuator circuit 19 used as an AGC circuit can obtain an AGC characteristic in which the PIN attenuator circuit 19 has a greatest gain when the AGC voltage v1 is the maximum AGC voltage, whereas the gain decreases when the AGC voltage v1 is decreased.

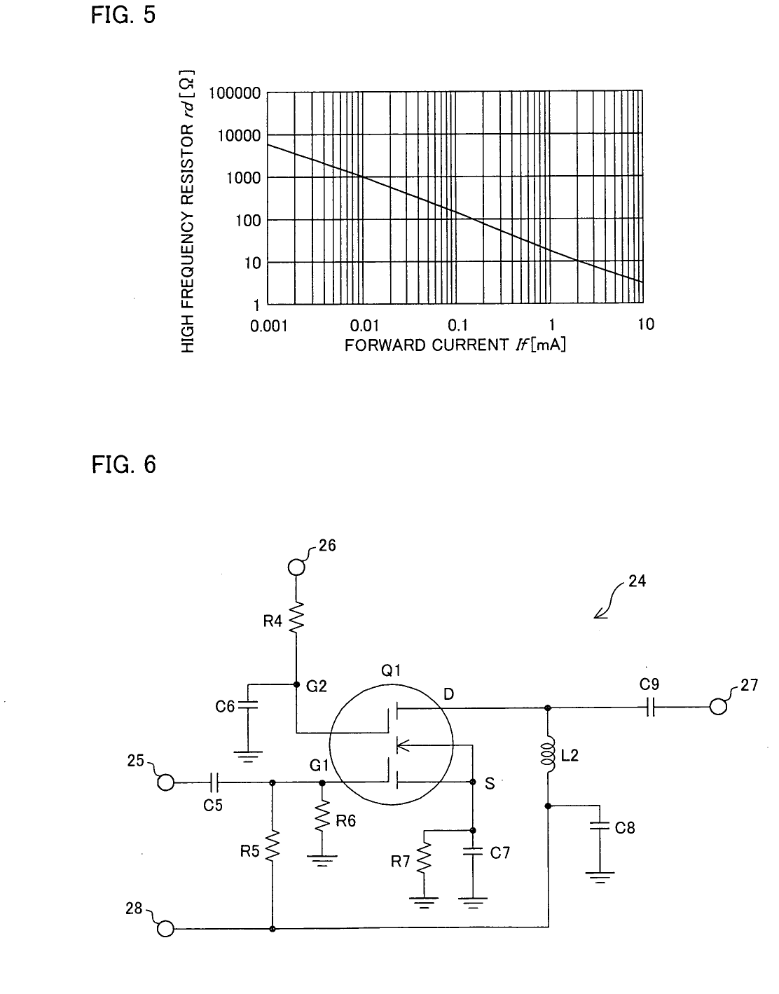

FIG. 6 is a circuit diagram of an AGC 24 which is used as the AGC circuit 6 of FIG. 1 in accordance with the present embodiment. A signal supplied from the broadband amplifying circuit 5 to an AGC circuit input terminal 25 of the AGC circuit 24 is sent out to the mixer circuit 7, via an AGC circuit output terminal 27 of the AGC circuit 24.

The AGC circuit 24 is a dual gate FET circuit including a dual gate FET Q1. A signal supplied via the AGC circuit input terminal 25 is sent out via the AGC circuit output terminal 27. A bias power supply is connected to a bias voltage input terminal 28, and a bias voltage required for driving the dual gate FET Q1 is applied to the bias voltage input terminal 28. The AGC circuit 24 has a characteristic in which: a gain increases when an AGC voltage (an AGC control signal) is increased which is supplied to a gate G2 from an AGC switching circuit 15, via an AGC control signal input terminal 26 and a resistor R4, whereas a gain decreases when an AGC voltage is decreased.

Resistors included in the AGC circuit 24 are configured as follows. One end of a resistor R5 is connected to a gate G1 of the dual gate FET Q1, and the other end of the resistor R5 is connected to the bias voltage input terminal 28. One end of a resistor R6 is connected to the gate G1 of the dual gate FET Q1, and the other end of the resistor R6 is connected to a GND. One end of a resistor R7 is connected to a source S of the dual gate FET Q1, and the other end of the resistor R7 is connected to a GND.

Capacitors included in the AGC circuit 24 are configured as follows. One end of a capacitor C5 is connected to the AGC circuit input terminal 25, and the other end of the capacitor C5 is connected to the gate G1 of the dual gate FET Q1. One end of a capacitor C6 is connected to a gate G2 of the dual gate FET Q1, and the other end of the capacitor C6 is connected to a GND. One end of a capacitor C7 is connected to the source S of the dual gate FET Q1, and the other end of the capacitor C7 is connected to a GND. One end of a capacitor C8 is connected to the bias voltage input terminal 28, and the other end of the capacitor C8 is connected to a GND. One end of a capacitor C9 is connected to a drain D of the dual gate FET Q1, and the other end of the capacitor C9 is connected to the AGC circuit output terminal 27.

A high frequency cutoff coil included in the AGC circuit 24 is configured such that one end of a high frequency cutoff coil L2 is connected to the drain D of the dual gate FET Q1, and the other end of the high frequency cutoff coil L2 is connected to the bias voltage input terminal 28.

In an configuration in which the PIN attenuator circuit 19 is used as the AGC circuit 4 and the AGC circuit 24 is used as the AGC circuit 6, when the AGC circuit 4 is caused to operate during receiving CATV broadcasting, it is possible to attain an excellent distortion characteristic and an excellent impedance matching characteristic without distorting RF signals which are amplified by the broadband amplifying circuit 5. Moreover, in the configuration, when the AGC circuit 6 is caused to operate during receiving terrestrial TV broadcasting, it is possible to reduce a noise included in signals which have passed through the AGC circuit 4 and the broadband amplifying circuit 5, thereby resulting in that a wide AGC control range with low-noise can be attained without deteriorating a receiving performance of a tuner.

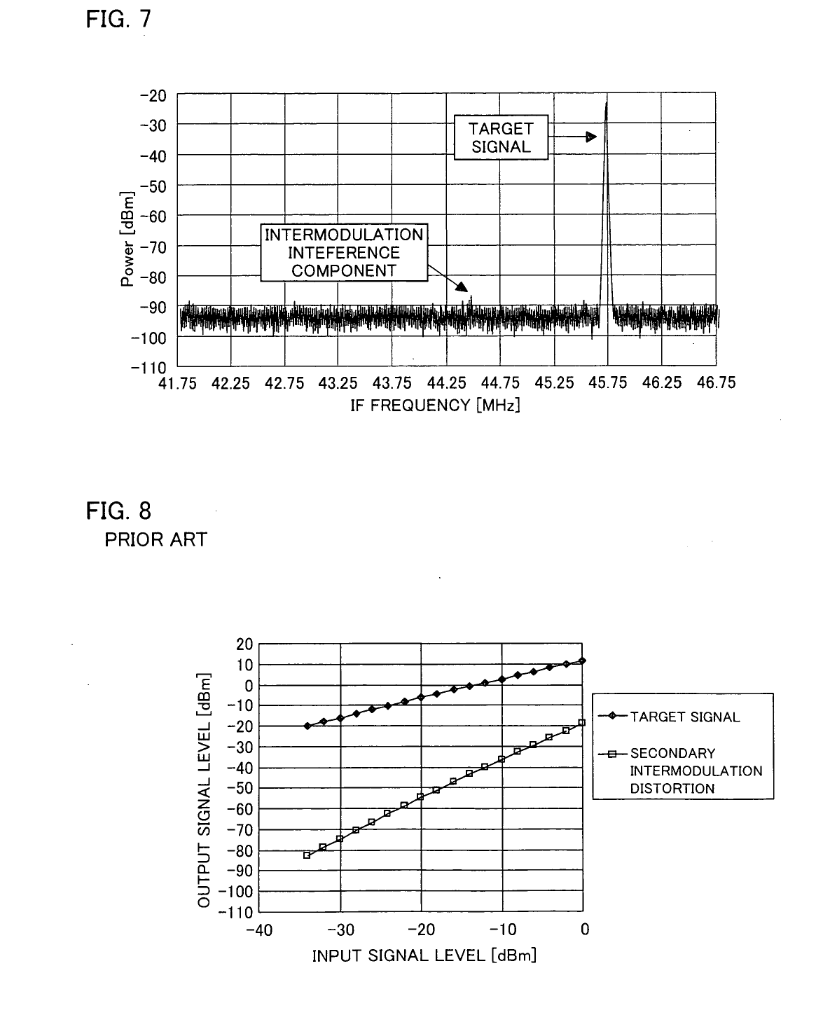

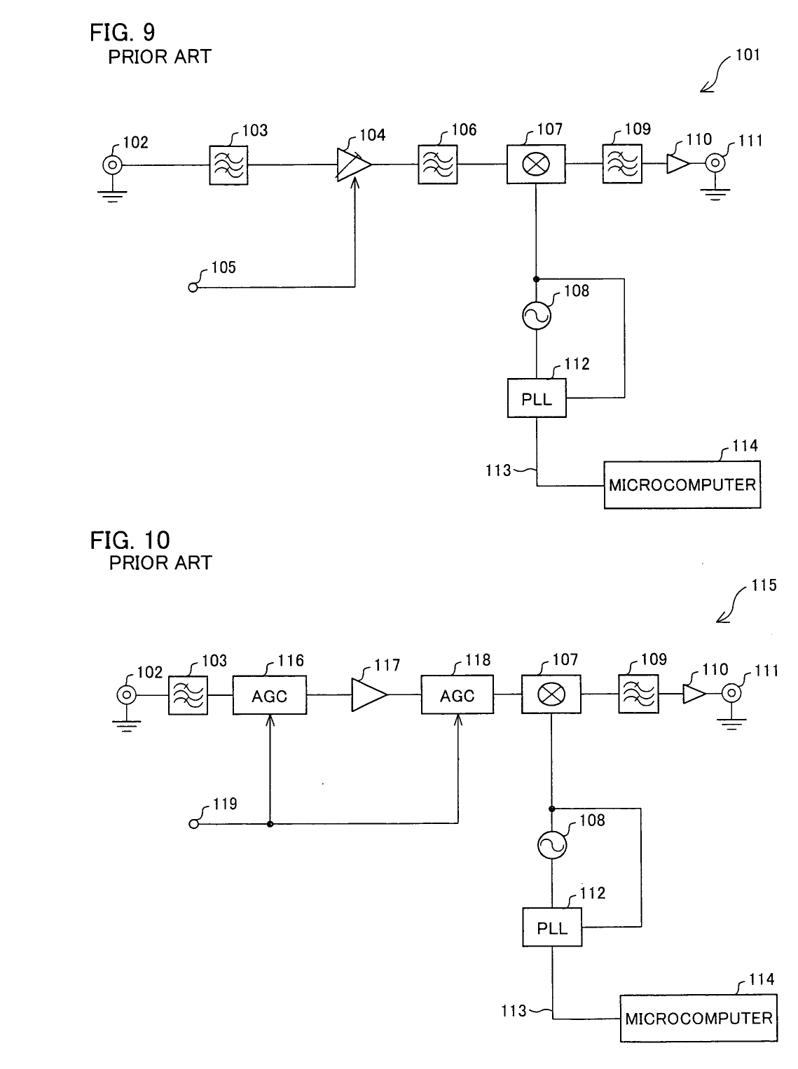

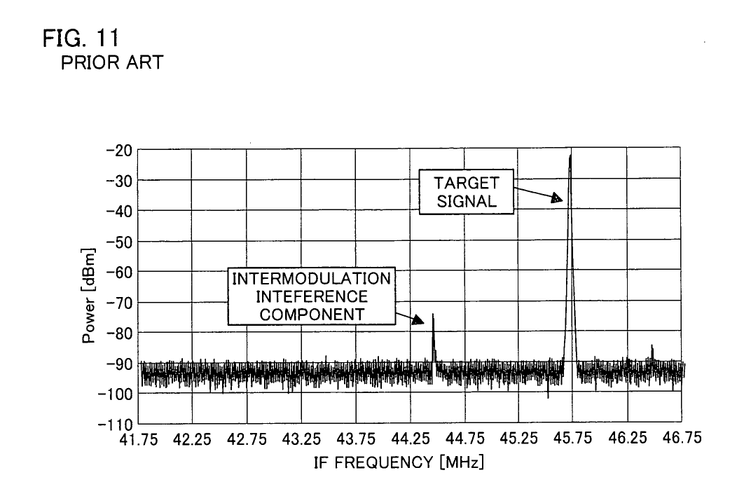

FIG. 7 is a frequency spectrum illustrating an intermodulation interference characteristic obtained when a common receiver for terrestrial TV and CATV of the present invention receives CATV broadcasting. As is clear from FIG. 7, an intermodulation interference component which occurs at a frequency band of 44.5 MHz is improved, as compared with a case where the conventional receiver receives CATV broadcasting (see FIG. 11).

### [Outline of the embodiment]

As described above, a tuner section 1 of a common receiver for terrestrial TV and CATV in accordance with the embodiment of the present invention includes: an RF signal input terminal 2 via which multichannel RF signals are supplied; an AGC circuit 4, by which the RF signal input terminal 2 is followed, for fixing or controlling a gain in accordance with a first gain control signal; a broadband amplifying circuit 5 by which the AGC circuit 4 is followed; an AGC circuit 6, by which the broadband amplifying circuit 5 is followed, for fixing or controlling a gain in accordance with a second gain control signal; a mixer circuit 7 for selecting and picking out a target channel signal from signals supplied from the AGC circuit 6; and an AGC switching circuit 15 for controlling the AGC circuit 4 and the AGC circuit 6 by selecting whether to fix or to control a gain of the AGC circuit 4 while selecting whether to fix or to control a gain of the AGC circuit 6.

With the circuit configuration of the tuner section 1 of the common receiver for terrestrial TV and CATV in accordance with the embodiment of the present invention, (i) one of the AGC circuit 4 followed by the broadband amplifying circuit 5 and the AGC circuit 6 by which the broadband amplifying circuit 5 is followed has a gain-fixed status and (ii) the other one of the AGC circuit 4 and the AG-C circuit 6 carries out a gain control, in accordance with whether a receiving signal is for CATV broadcasting or for terrestrial TV broadcasting.

With the configuration, it is possible to realize an excellent common receiver for terrestrial TV and CATV, having a good receiving performance with little noise and beat, in which an excellent distortion characteristic is ensured for receiving CATV broadcasting and a low-noise characteristic is ensured for receiving terrestrial TV broadcasting.

In the tuner section 1 of the common receiver for terrestrial TV and CATV, one of the AGC circuit 4 and the AGC circuit 6 may have a fixed gain and the other one of the AGC circuit 4 and the AGC circuit 6 may have a gain which is controlled.

With the configuration, when a gain of the AGC circuit 4 is fixed during receiving terrestrial TV broadcasting and a gain of the AGC circuit 6 is controlled, it is possible to totally reduce a noise figure of the common receiver for terrestrial TV and CATV. This allows an improvement in noise characteristic. When a gain of the AGC circuit 6 is fixed during receiving CATV broadcasting and a gain of the AGC circuit 4 is controlled, it is avoided that the broadband amplifying circuit 5 outputs a distorted signal. This allows an improvement in distortion characteristic.

The tuner section 1 of the common receiver for terrestrial TV and CATV may receive first and second types of broadcasting signals, the first type being CATV broadcasting signals which are multichannel RF signals to be transmitted via a cable, and the second type being terrestrial TV broadcasting signals which are multichannel RF signals to be transmitted via a radio wave.

With the configuration, it is possible that both of CATV broadcasting signals and terrestrial TV broadcasting signals are received by a single receiver.

In the tuner section 1 of the common receiver for terrestrial TV and CATV, the AGC circuit 6 may have a fixed gain and the AGC circuit 4 may have a gain which is controlled, when the CATV broadcasting signals are received.

This allows a reduction in distortion of an output signal of the broadband amplifying circuit 5, and an improvement in distortion characteristic.

In the tuner section 1 of the common receiver for terrestrial TV and CATV, the AGC circuit 4 may have a fixed gain and the AGC circuit 6 may have a gain which is controlled, when the terrestrial TV broadcasting signals are received.

This allows a reduction in noise figure of the common receiver for terrestrial TV and CATV in total, and an improvement in noise characteristic.

In the tuner section 1 of the common receiver for terrestrial TV and CATV, the fixed gain of the AGC circuit 4 or the fixed gain of the AGC circuit 6 may be a maximum gain which causes supplied signals to have a minimal attenuation.

This can prevent attenuation of signals as much as possible, thereby restraining an affection caused by a noise to the minimum.

In the tuner section 1 of the common receiver for terrestrial TV and CATV, the mixer circuit 7 may select and pick out the target channel signal, with the use of digital data. When the common receiver for terrestrial TV and CATV includes a data bus 18 via which the digital data is transmitted, (i) whether to fix or to control a gain of the AGC circuit 4 and (ii) whether to fix or to control a gain of the AGC circuit 6 may be controlled in accordance with the digital data supplied via the data bus 18.

The configuration makes it possible to electrically control the AGC circuit 4 and the AGC circuit 6 instead of providing a mechanical switch.

In the tuner section 1 of the common receiver for terrestrial TV and CATV, the digital data to be transmitted may include first digital data for causing the AGC circuit 4 to have a first fixed gain; and second digital data for causing the AGC 6 to have a second fixed gain.

In a case where single digital data for controlling gains of the AGC circuit 4 and the AGC circuit 6 are shared by them, this causes the AGC circuit 6 to have an excessive gain, thereby resulting in that the common receiver for terrestrial TV and CATV has entirely an excessive gain, so that amplified signals have distortions. In such a case, it is possible to reduce distortions of amplified signals, when the AGC circuit 4 has a first fixed gain and the AGC circuit 6 has a second fixed gain which is different from and smaller than the first fixed gain.

In the tuner section 1 of the common receiver for terrestrial TV and CATV, the AGC circuit 4 may be realized by a PIN attenuator circuit 19 which changes a gain by changing a voltage (the first gain control signal) to be supplied via the AGC control signal input terminal 20 so that each high-frequency resistor rd of the diodes D1 through D3, which are connected in series, is changed. In this case, the PIN attenuator circuit 19 includes: diodes D1 through D3 having a characteristic in which a high-frequency resistor rd varies in accordance with a change in forward current If; and an AGC control signal input terminal 20 via which the first gain control signal, causing the currents flowing the diodes D1 through D3 to be controlled, is supplied.

This allows the AGC circuit 4 to have a characteristic in which the AGC circuit 4 has a maximum gain when a voltage, causing signals to have a minimal attenuation, is supplied via the AGC control signal input terminal 20, whereas the gain decreases when a voltage to be supplied to the AGC control signal input terminal 20 decreases.

In the tuner section 1 of the common receiver for terrestrial TV and CATV, the AGC circuit 6 may be realized by a dual gate FET circuit in which a dual gate FET Q1 and an AGC control signal input terminal 26 are provided, a gate G1 of the dual gate FET Q1 is grounded via a resistor R6, and a gain is changed by controlling a control signal voltage (the second gain control signal) to be supplied to a gate G2 of the dual gate FET Q1, via the AGC control signal input terminal 26 and a resistor R4.

This allows the AGC circuit 6 to have a characteristic in which a gain increases as a voltage to be supplied via the AGC control signal input terminal 26 increases, whereas the gain decreases as a voltage to be supplied via the AGC control signal input terminal 26 decreases.

The embodiment discussed in the foregoing detailed explanation serves solely to illustrate the technical details of the present invention, which should not be narrowly interpreted within the limits of such embodiments, but rather may be applied in many variations within the spirit of the present invention, provided such variations do not exceed the scope of the patent claims set forth below.

What is claimed is:

1. A common receiver for terrestrial TV and CATV comprising:
an RF signal input terminal via which multichannel RF signals are supplied;
first gain control means, by which the RF signal input terminal is followed, for fixing or controlling a gain in accordance with a first gain control signal;
an RF signal amplifier, by which the first gain control means is followed;
second gain control means, by which the RF signal amplifier is followed, for fixing or controlling a gain in accordance with a second gain control signal;
a channel select circuit for selecting and picking out a target channel signal from signals supplied from the second gain control means; and
control means for controlling gains of the first gain control means and the second gain control means by selecting whether to fix or to control a gain of the first gain control means while selecting whether to fix or to control a gain of the second gain control means.

2. The common receiver for terrestrial TV and CATV as set forth in claim 1, wherein one of the first and second gain control means has a fixed gain and the other one of the first and second gain control means has a gain which is controlled.

3. The common receiver for terrestrial TV and CATV as set forth in claim 2, wherein first and second types of broadcasting signals, the first type being CATV broadcasting signals which are multichannel RF signals to be transmitted via a cable, and the second type being terrestrial TV broadcasting signals which are multichannel RF signals to be transmitted via a radio wave.

4. The common receiver for terrestrial TV and CATV as set forth in claim 3, wherein the second gain control means has a fixed gain and the first gain control means has a gain which is controlled, when the CATV broadcasting signals are received.

5. The common receiver for terrestrial TV and CATV as set forth in claim 3, wherein the first gain control means has a fixed gain and the second gain control means has a gain which is controlled, when the terrestrial TV broadcasting signals are received.

6. The common receiver for terrestrial TV and CATV as set forth in claim 4, wherein the fixed gain of the second gain control means is a maximum gain which causes supplied signals to have a minimal attenuation.

7. The common receiver for terrestrial TV and CATV as set forth in claim 5, wherein the fixed gain of the first gain control means is a maximum gain which causes supplied signals to have a minimal attenuation.

8. The common receiver for terrestrial TV and CATV as set forth in claim 4, wherein the channel select circuit selects and picks out the target channel signal, by use of digital data,
said receiver further comprising a control bus line via which the digital data is transmitted,
wherein:
(i) whether to fix or to control a gain of the first gain control means and (ii) whether to fix or to control a gain of the second gain control means are controlled in accordance with the digital data supplied via the control bus line.

9. The common receiver for terrestrial TV and CATV as set forth in claim 5, wherein the channel select circuit selects and picks out the target channel signal, by use of digital data,
said receiver further comprising a control bus line via which the digital data is transmitted,
wherein:
(i) whether to fix or to control a gain of the first gain control means and (ii) whether to fix or to control a gain of the second gain control means are controlled in accordance with the digital data supplied via the control bus line.

10. The common receiver for terrestrial TV and CATV as set forth in claim 6, wherein the channel select circuit selects and picks out the target channel signal, by use of digital data,
said receiver further comprising a control bus line via which the digital data is supplied,
wherein:
(i) whether to fix or to control a gain of the first gain control means and (ii) whether to fix or to control a gain of the second gain control means are controlled in accordance with the digital data supplied via the control bus line.

11. The common receiver for terrestrial TV and CATV as set forth in claim 7, wherein the channel select circuit selects and picks out the target channel signal, by use of digital data,
said receiver further comprising a control bus line via which the digital data is supplied,
wherein:
(i) whether to fix or to control a gain of the first gain control means and (ii) whether to fix or to control a gain of the second gain control means are controlled in accordance with the digital data supplied via the control bus line.

12. The common receiver for terrestrial TV and CATV as set forth in claim 8, wherein:
the digital data to be transmitted include:
first digital data for causing the first gain control means to have a first fixed gain; and
second digital data for causing the second gain control means to have a second fixed gain.

13. The common receiver for terrestrial TV and CATV as set forth in claim 9, wherein:
the digital data to be transmitted include:
first digital data for causing the first gain control means to have a first fixed gain; and
second digital data for controlling the second gain control means to have a second fixed gain.

14. The common receiver for terrestrial TV and CATV as set forth in claim 10, wherein:
the digital data to be transmitted include:
first digital data for causing the first gain control means to have a first fixed gain; and
second digital data for causing the second gain control means to a second fixed gain.

15. The common receiver for terrestrial TV and CATV as set forth in claim 11, wherein:
the digital data to be transmitted include:
first digital data for causing the first gain control means to have a first fixed gain; and
second digital data for causing the second gain control means to have a second fixed gain.

16. The common receiver for terrestrial TV and CATV as set forth in claim 1, wherein:
the first gain control means is realized by a PIN attenuator circuit,
said PIN attenuator circuit including:
first through third PIN diodes having a characteristic in which a high-frequency resistor varies in accordance with a change in forward current; and
a first current control terminal via which the first gain control signal, causing the currents flowing the first through third PIN diodes to be controlled, is supplied,
a gain being changed by changing a voltage, which is the first gain control signal, to be supplied via the first current control terminal so that each high-frequency resistor of the first through third PIN diodes, which are connected in series, is changed.

17. The common receiver for terrestrial TV and CATV as set forth in claim 2, wherein:
the first gain control means is realized by a PIN attenuator circuit,
said PIN attenuator circuit including:
first through third PIN diodes having a characteristic in which a high-frequency resistor varies in accordance with a change in forward current; and
a first current control terminal via which the first gain control signal, causing the currents flowing the first through third PIN diodes to be controlled, is supplied,
a gain being changed by changing a voltage, which is the first gain control signal, to be supplied via the first current control terminal so that each high-frequency resistor of the first through third PIN diodes, which are connected in series, is changed.

18. The common receiver for terrestrial TV and CATV as set forth in claim 3, wherein:
the first gain control means is realized by a PIN attenuator circuit,
said PIN attenuator circuit including:
first through third PIN diodes having a characteristic in which a high-frequency resistor varies in accordance with a change in forward current; and
a first current control terminal via which the first gain control signal, causing the currents flowing the first through third PIN diodes to be controlled, is supplied,
a gain being changed by changing a voltage, which is the first gain control signal, to be supplied via the first current control terminal so that each high-frequency resistor of the first through third PIN diodes, which are connected in series, is changed.

19. The common receiver for terrestrial TV and CATV as set forth in claim 14, wherein:
the first gain control means is realized by a PIN attenuator circuit:
said PIN attenuator circuit including:
first through third PIN diodes having a characteristic in which a high-frequency resistor varies in accordance with a change in forward current; and
a first current control terminal via which the first gain control signal, causing the currents flowing the first through third PIN diodes to be controlled, is supplied,
a gain being changed by changing a voltage, which is the first gain control signal, to be supplied via the first current control terminal so that each high-frequency resistor of the first through third PIN diodes, which are connected in series, is changed.

20. The common receiver for terrestrial TV and CATV as set forth in claim 15, wherein:
the first gain control means is realized by a PIN attenuator circuit,
said PIN attenuator circuit including:
first through third PIN diodes having a characteristic in which a high-frequency resistor varies in accordance with a change in forward current; and
a first current control terminal via which the first gain control signal, causing the currents flowing the first through third PIN diodes to be controlled, is supplied,
a gain being changed by changing a voltage, which is the first gain control signal, to be supplied via the first current control terminal so that each high-frequency resistor of the first through third PIN diodes, which are connected in series, is changed.

21. The common receiver for terrestrial TV and CATV as set forth in claim 1, wherein:
the second gain control means is realized by a dual gate FET circuit in which a dual gate FET and a second current control terminal are provided, a first gate of the dual gate FET is grounded via a resistor, and a gain is changed by controlling a control signal voltage, which is the second gain control signal, to be supplied to a second gate of the dual gate FET, via the second current control terminal and a resistor.

22. The common receiver for terrestrial TV and CATV as set forth in claim 2, wherein
the second gain control means is realized by a dual gate FET circuit in which a dual gate FET and a second current control terminal are provided, a first gate of the dual gate FET is grounded via a resistor, and a gain is changed by controlling a control signal voltage, which is the second gain control signal, to be supplied to a second gate of the dual gate FET, via the second current control terminal and a resistor.

23. The common receiver for terrestrial TV and CATV as set forth in claim 3, wherein
the second gain control means is realized by a dual gate FET circuit in which a dual gate FET and a second current control terminal is provided, a first gate of the dual gate FET is grounded via a resistor, and a gain is changed by controlling a control signal voltage, which is the second gain control signal, to be supplied to a second gate of the dual gate FET, via the second current control terminal a resistor.

24. The common receiver for terrestrial TV and CATV as set forth in claim 14, wherein
the second gain control means is realized by a dual gate FET circuit in which a dual gate FET and a second current control terminal is provided, a first gate of the dual gate FET is grounded via a resistor, and a gain is changed by controlling a control signal voltage, which is the second gain control signal, to be supplied to a second gate of the dual gate FET, via the second current control terminal a resistor.

25. The common receiver for terrestrial TV and CATV as set forth in claim 15, wherein
the second gain control means is realized by a dual gate FET circuit in which a dual gate FET and a second current control terminal is provided, a first gate of the dual gate FET is grounded via a resistor, and a gain is changed by controlling a control signal voltage, which is the second gain control signal, to be supplied to a second gate of the dual gate FET, via the second current control terminal a resistor.
